(19) United States
(12) Patent Application Publication
(10) Pub. No.: US 2005/0235566 A1
(43) Pub. Date: Oct. 27, 2005

(54) Continuously controlled window regulator, coupling disc and guide plate for said continuously controlled window regulator

(76) Inventor: Frank Fassbender, Coburg (DE)

Correspondence Address: CHRISTIE, PARKER & HALE, LLP, PO BOX 7068, PASADENA, CA, 91109-7068, US

(21) Appl. No.: 10/524,232

(22) PCT Filed: Aug. 20, 2003
(86) PCT No.: PCT/DE03/02835

§ 371 Date: Feb. 9, 2005

(30) Foreign Application Priority Data
Aug. 21, 2002 (DE) 202127744.5

(51) Int. Cl. E05F 11/38

(52) U.S. Cl. 49/349; 49/348

(57) ABSTRACT

The invention relates to a continuously controlled window regulator which comprises a coupling disc arranged on a guide plate in a motor vehicle and can he displaced along a displacement trajectory formed by a window guide rail. Said coupling disc comprises guiding elements which arc arranged on the window guide rail, on the front and rear edges of the guide plate. At least the first guiding element arranged on the front edge of the guide plate and at least the second guiding element arranged on the rear edge thereof are disposed in such a way that they arc movable with respect to each other for mounting. The first guiding element can be placed into a mounting position in order to be mounted on the guide rail of the guide plate. The coupling disc can be pre-produced in the form of an individual element with the aid of plug pins and positioned on the guide plate in the mounting position in such a way that it is movable across the opening of the guide rail and afterwards fixable in a desired position with a bayonet movement of the second guiding element.

The invention relates to a continuously controlled window lifter, as well as to a follower and a guide plate for the continuously controlled window lifter.

Continuously controlled window lifters in motor vehicles are used to enable complex movement of the window pane in a rear vehicle door. By way of example it is necessary to move the rear window pane on lowering into the vehicle door in a motion about the rear wheel box. A continuously controlled window lifter of this kind is known from DE 34 45 000 A1 in which the continuously controlled window lifter is provided in a vehicle door for raising and lowering the window pane between a fully closed position and a fully opened position. The window lifter hereby comprises an elongated plate which is fixed on the door and supports at least one inclined guide rail.

The guide rail is fixed on the plate by way of example through a rivet connection and has a C-shaped cross-section in which slide members of a support of the window pane are mounted for sliding movement. The C-shaped cross-section of the guide rails enables the two arms of the C-profile to be arranged at right angles. The slide member is thereby matched to the C-profile of the guide rail and has slide faces formed at right angles to each other. The support having the slide members is fixed on the window pane and supports the slide member so that the movement of the slide member inside the C-profile of the guide rail leads to a corresponding displacement of the window pane.

Further guides enable a swivel action of the window pane during the movement. A flexible wire is connected to the region of the support of the window pane and is movable through a drive unit inside the door. The movement of the wire is transferred to the support and thus to the window pane. The drawback with the continuously controlled window lifter illustrated in DE 34 45 000 A1 however is that in addition to the plate the guide rails have to be made separately and have to be fixed with the plate in a subsequent work step. The manufacturing tolerances of the individual guide rails as well as the local tolerances of the fixing thereof can lead to an undesired displacement of the adjusting path and thus to inadequate closing of the window pane.

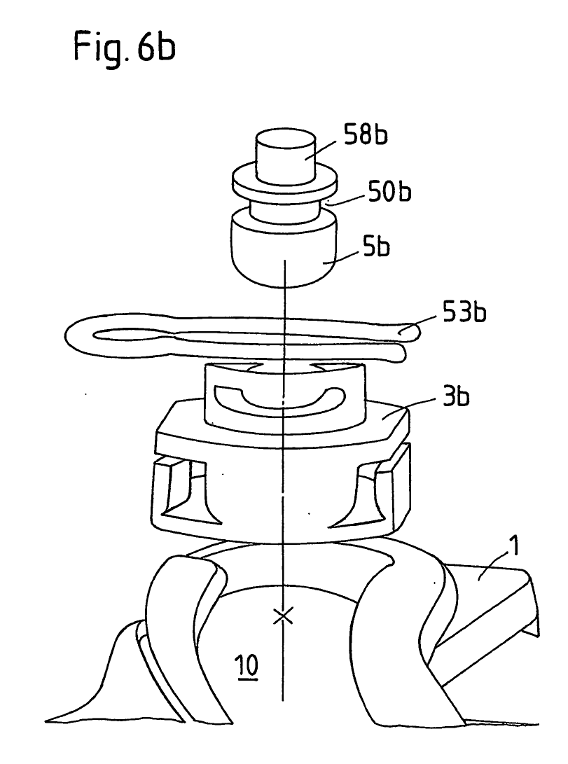

In order to overcome the drawbacks of DE 34 45 000 A1, guide ways are stamped in the plate as shown in FIG. 6 and are used in the run-on systems of continuously controlled window lifters. The sectional view of FIG. 6 shows a section of a guide plate 1 which has a guide way 12 with an opening 10. The opening 10 is engaged by a multi-part follower 2. The follower 2 has guide elements 31 and 32 which are mounted to slide on the guide way 12 either side of the guide plate 1. The slide elements 31 and 32 thereby enable guidance in two directions, in the illustrated Y direction and in the illustrated X direction whilst the window pane is moved substantially in the Z direction.

The slide elements 31, 32 are held together through a stepped bolt 5 and through a screw 6. Between the screw 6 and stepped bolt 5 there are in addition to the guide elements 31, 32 also two plate springs 51 and 61 which compensate both manufacturing tolerances and also tolerances in the angle of the path faces 131 and 132 over the displacement path. The variation in the angle is caused in that the stamping direction for producing the guide way 12 with the opening 10 is the same for all the guide ways 12 and over the entire adjusting path of the relevant guide way 12, but the geometry of the adjusting path 12 changes over the adjusting path in order to allow the window pane to swivel in several three-dimensional directions (X, Y, Z). Furthermore the stepped bolt 5 is connected through a rivet connection 58 to a lift rail 8 to which a window pane (not shown in FIG. 6) can be fixed.

As a result of the resistance to movement generated over the adjusting path through the manufacturing tolerances as well as the variable angle the object of the invention is to provide a follower, guide plate and a continuously controlled window lifter which can be manufactured easily, has improved sliding properties and avoids the use of an additional guide rail.

This is achieved through the features of the independent claims. Further advantageous developments of the invention will be indicated in the sub-claims.

Consequently the follower of the continuously controlled window lifter consists of several elements which are to be mounted. At least a first guide element is mounted displaceable on the first side of the guide plate and at least a second guide element is mounted displaceable on the second side of the guide plate so that the follower is guided through the sides of the guide plate. The guide elements are preferably mounted to slide on the guide plate but alternatively could also have rolling or roller guides.

The second guide element is held in an assembly position relative to the first guide element or alternatively or in combination with another element of the follower through associated engagement regions. This assembly position enables several elements of the follower to be combined into one structural group prior to fitting and to be pre-fabricated for example separately from the guide plate. Another element of the follower which can be associated with the engagement region of the second guide element is by way of example a lifting rail or a stepped bolt of the follower. In this assembly position the prefabricated structural group of the follower can be set on the guide way by passing the second guide element through an opening in the guide way.

At least for assembly the first guide element and the second guide element are mounted movable relative to each other so that at least the second guide element can be brought from the assembly position into a functioning position on the guide way of the guide plate. The movable bearing is preferably used for assembly in order to fit the structural group of the follower on the guide way. However the bearing need not be restricted to the assembly process. The bearing can be used by way of example for a restricted movement of the second guide element in the functioning case.

In order to ensure secure hold in the assembly position so that the second guide element does not move by itself into a position deviating from the assembly position there are different suitable advantageous embodiments of the invention.

In the first design the engagement regions are formed as a detachable positive locking connection for a secure hold in the assembly position. A detachable positive locking connection is for example a toothed connection or a detent nose/detent groove arrangement. The positive locking connection can thereby be released manually or through an automatic mechanism whereby for example actuating elements of the follower are provided which automatically release this positive locking connection during fitting onto the guide plate.

Alternatively or in combination in a second embodiment of the invention the engagement regions are designed as a releasable force locking connection for the secure hold in the assembly position. The force locking connection is produced for example by two rough surfaces of the engagement regions which are pressed against each other through pressure or spreading movement.

A particularly advantageous third development proposes that for the secure hold in the assembly position the engagement regions are disengaged as a rupturable regions. Both elements having the engagement regions are connected together at manufacture by way of example through a film hinge. The film hinge is destroyed during fitting as a ruptiurable region and the second guide element is brought into the functioning position.

The movable bearing can enable for example rotational, translatory, arcuate or other movements of the second guide element.

In order to enable a particularly simple bayonet-type positioning of the second guide element in a further advantageous development of the invention the first guide element and the second guide element are mounted for pivotal or rotational movement relative to each other. The bearing can thereby be formed directly for example on a ball joint formed from the first guide element and the second guide element or on a further element of the follower, for example the stepped bolt. Alternatively the first guide element and second guide element are mounted displaceable relative to each other, more particularly through sliding translation movement.

If a fixed positioning of the first guide element relative to the second guide element is desired then in a particularly advantageous further development of the invention the first guide element and the second guide element are fixed relative to each other in the functioning position through a further positive locking connection or force locking connection or through a combination of positive locking and force locking engagement. This fixing is not to be released during the operation of the continuously controlled window lifter but release is advantageously possible in the event of repair. Advantageously at least one of the engagement regions of the assembly position is used in a double function for fixing in the functioning position.

In order to enable this flexible handling of the fixing in a further advantageous development of the invention a locking element is provided for locking the fixing of the functioning position. This locking element can in addition to the actual locking function also undertake further functions, by way of example housing the nipple of the driving window lifter cable.

A further preferred development of the invention proposes that the follower has several slide members which each have at least one first guide element and at least one second guide element. At least the second guide elements of the slide members are mounted movable relative to a lifting rail. More particularly these can be rotated and aligned relative to the position of the lifting rail. The second guide elements are consequently positioned in the assembly position relative to each other or to the lifting rail. The second guide elements of the slide members are movable in a following assembly step from the assembly position into the functioning position.

In order to hold the second guide elements securely in their functioning position during the positioning of the follower on the guide plate, in a particularly advantageous development of this feature of the invention the lifting rail has engagement regions, more particularly positioning detent elements which in the engagement regions of the second guide elements or with the engagement regions of the first guide elements cause a secure hold in the assembly position.

Preferably the positioning detent element of the lifting rail is formed as a pin which can be inserted in the lifting rail. This pin is by way of example flexible so that the holding force can be manually overcome or the pin preferably has a rupturable region which can be destroyed by assembly force during assembly. The pin can thereby likewise be made as an integral element of the lifting rail or a guide element.

According to the invention the second guide element is mounted movable relative to the first guide element. In an advantageous development of this bearing of the invention the second guide element is mounted for this movable bearing rotatable on the first guide element or on a stepped bolt of the follower. This rotatable bearing enables the second guide element to be moved around 90° so that the latter is guided in the assembly position through an opening of the guide way and can then be turned 90° into the functioning position. In addition or as an alternative to this rotational bearing further bearings can be used such as a (displaceable) transversal bearing on the stepped bolt. By way of example as an alternative, folding and engaging the second guide element over a folding joint into the functioning position is also possible.

A second aspect of the invention is a guide plate of the continuously controlled window lifter. This guide plate has a guide way for guiding a follower which has for example a structural design as previously explained. The follower is moved along an adjusting path formed by the guide way. For guidance the guide way of the guide plate has a guide web which guides the follower along the adjusting path in the plane of the guide way. In order to enable a simplified assembly of the follower the height of this guide web is reduced in a region for fitting the follower. This lower web height enables in the assembly region the second guide element to turn over the lower web into the functioning position whereby for example slide faces of the second guide element are brought over the guide web to the guide way faces adjoining the guide web.

Preferably the guide way has on either side of the guide plate and additionally on the guide web guide way faces which are each associated with at least one guide element of the follower. This guidance through the guide web can be integrated in the first guide element or the second guide element, preferably however a separate third guide element of the follower is provided for guidance along the guide web. The guide plate has an opening in the guide way, for example adjacent a guide way surface associated with the first or second guide element, along the adjusting path, through which the follower can be fitted in the region of the fitting. Preferably the second guide element is thereby able to swivel or rotate into an assembly position in which this second guide element can be brought through the opening of the guide plate associated with the guide way from the first side of the guide plate to the second side of the guide plate and in this functioning position engages through the opening in the guide way.

A third aspect of the invention is a guide plate with an assembly region for fitting the follower which is formed in the extension of the guide way in the guide plate. This region is no longer reached in following regulating adjustments of the window lifter after fitting in the functioning position so that the follower is prevented in this assembly region from falling out during operation of the window lifter. The opening in this region is widened out to allow the follower to slide onto the guide way for fitting. The widened opening acts like a keyhole through which the guide elements of the follower can be pushed for example onto the guide way.

A fourth aspect of the invention provides a follower which has at least a second guide element on the second side of the guide plate and between two guide ways of the guide way a third guide element whose width is extended between the guide webs. The follower is mounted for sliding movement with the guide elements on the guide ways. The width of the third guide element can be adjusted by an expanding element or by a mechanism which adjusts the width of the third guide element. Preferably the third guide element is set to the distance between the two guide webs so that a substantially play-free adjustment is possible.

In a fifth aspect of the invention the functional group of a continuously controlled window lifter is provided. The window lifter has a follower which is connected to the window pane and can be driven by means of a drive mechanism for adjusting the window pane. A guide way is provided for adjusting the follower along an adjusting path formed by the guide way substantially in the Z-direction and for guiding the follower in a first guide direction substantially perpendicular to the adjusting direction of an adjusting path section and for guiding the follower in a second guide direction substantially perpendicular to the adjusting direction of the adjusting path section. The first guide direction thereby forms relative to the second guide direction an angle which is variable over the adjusting path. The variable angle between the two guide directions is formed by way of example through the deviation of the stamped bending direction from the orthogonal to the web face.

The guide way has an opening in the guide plate of the window lifter which is engaged by the follower. This is used so that the guide way can have for guidance either side of the guide plate guide way faces associated with the guide elements of the follower. The guide elements are preferably mounted for sliding movement on the guide way faces. The follower of the continuously controlled window lifter thereby has at least one first guide element for guidance in the first guide direction, more particularly in the x-direction, and a second guide element for guidance in the second guide direction, more particularly in the y-direction.

These guide elements and/or other elements of the follower have a bearing by means of which the guide elements are mounted movable relative to each other. The position of the mounted guide elements is thereby dependent on the variable angle of the guide web relative to the guide way faces over the adjusting path. In addition spring elements can be provided which prevent play and thus noises arising in the bearing.

Preferably the first guide element and the second guide element are mounted to swivel or rotate relative to each other by means of a swivel bearing or rotational bearing. Apart from this swivel bearing or rotational bearing further bearings are also possible which compensate the said angular movement.

In an advantageous development of the invention the first guide element is mounted on a ball joint. The ball joint is thereby formed in one piece with the second guide element. A further possible development consists in the use of a domed bearing whereby advantageously the first guide element is mounted on a domed bearing of the second guide element. Alternatively or in combination the second guide element can also be mounted on a tilt joint of the first guide element.

A particularly preferred bearing provides a tilting bearing whereby the first guide element is mounted for tilting movement on a stepped bolt of the follower which engages through the opening in the guide plate.

In order to guide the follower along the adjusting path the follower is guided in a first guide direction substantially orthogonal to the surface of the guide plate. Moreover guidance is provided in a second guide direction through restrictions of an opening in the guide way, by way of example a guide web as restriction. The guidance over the restriction of the opening of the guide way is substantially in the drive direction (X-direction) whereby for guidance in this second guide direction only two of the three necessary slide members with corresponding guide elements are required.

If the third slide member also has a guide element in the second guide direction (X-direction) this guide is overruled resulting in heavy-going movement and jamming. If nevertheless the slide members are also to be made as identical parts in a further aspect of the invention a continuously controlled window lifter has a follower for guidance along the adjusting path with several slide members which are mounted to slide on at least a first, a second and a third guide way of the guide plate and each engage through an opening in the guide way.

The opening in the first guide way is wider than that in the second and third guide ways; preferably this first guide way is an outer guide way in order to enable the largest possible acting rotational force of the window lifter on the window pane. The follower is consequently only guided in the second guide direction through the second guide way and the third guide way.

The invention will now be explained below in further detail with reference to embodiments illustrated in the drawings.

These show:

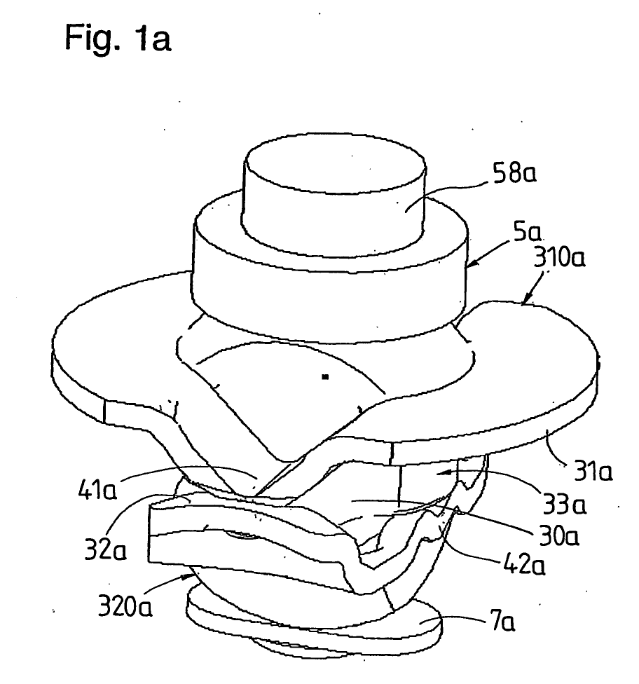

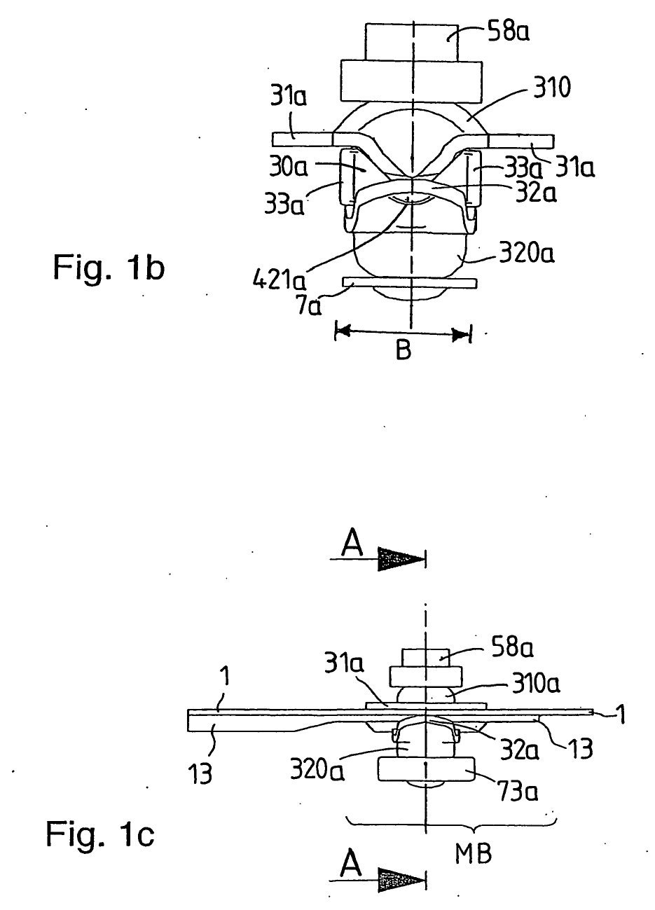

FIG. 1a a three-dimensional view of a follower of a continuously controlled window lifter in an assembly position;

FIG. 1b a side view of the follower of the continuously controlled window lifter;

FIG. 1c a side view of a mounted follower of a continuously controlled window lifter;

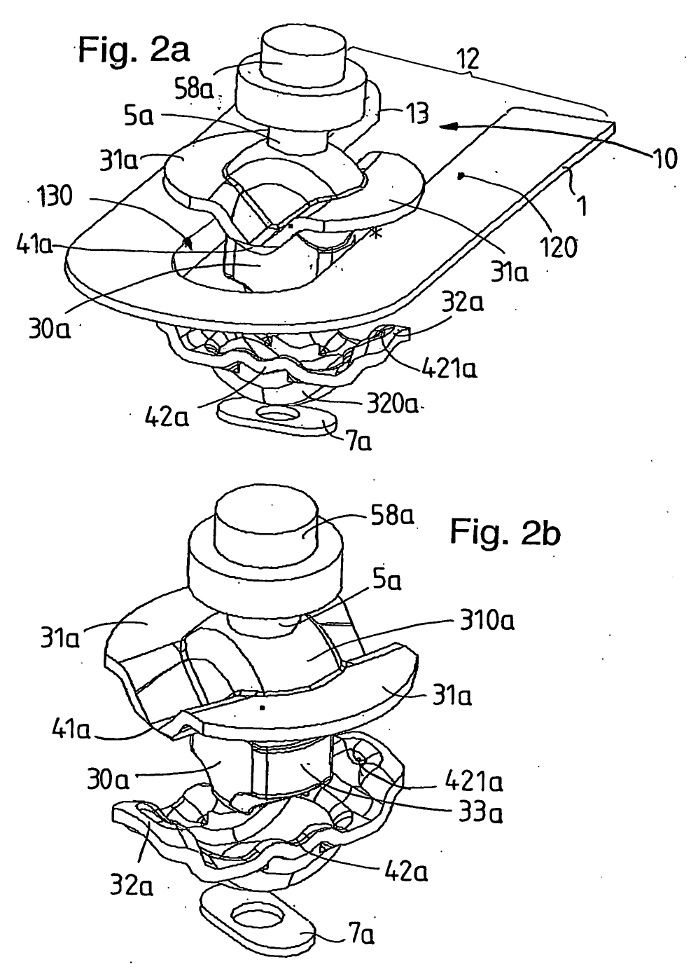

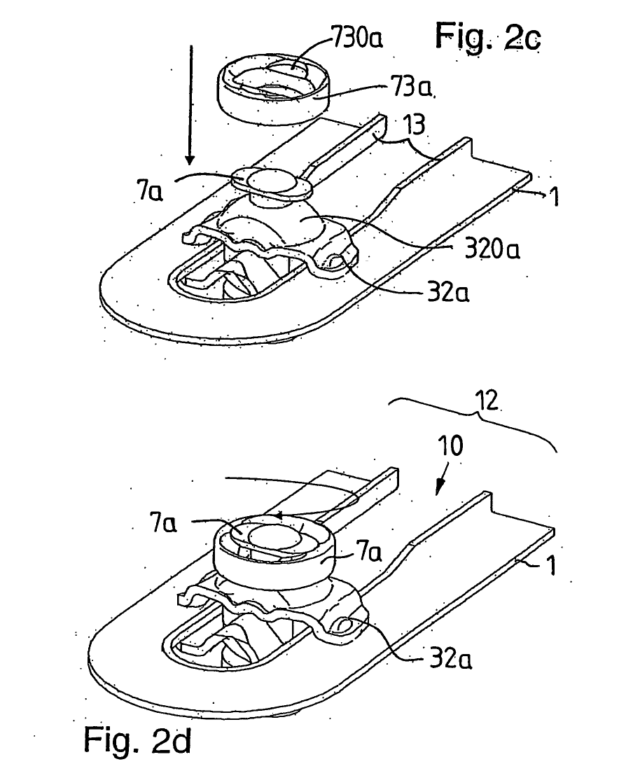

FIG. 2a an exploded view of a follower of a continuously controlled window lifter in position relative to a guide way;

FIG. 2b an exploded view of a follower

FIG. 2c a three dimensional view of a fitting situation for a follower on a guide way;

FIG. 2d a further assembly step of a follower on a guide-way of a continuously controlled window lifter;

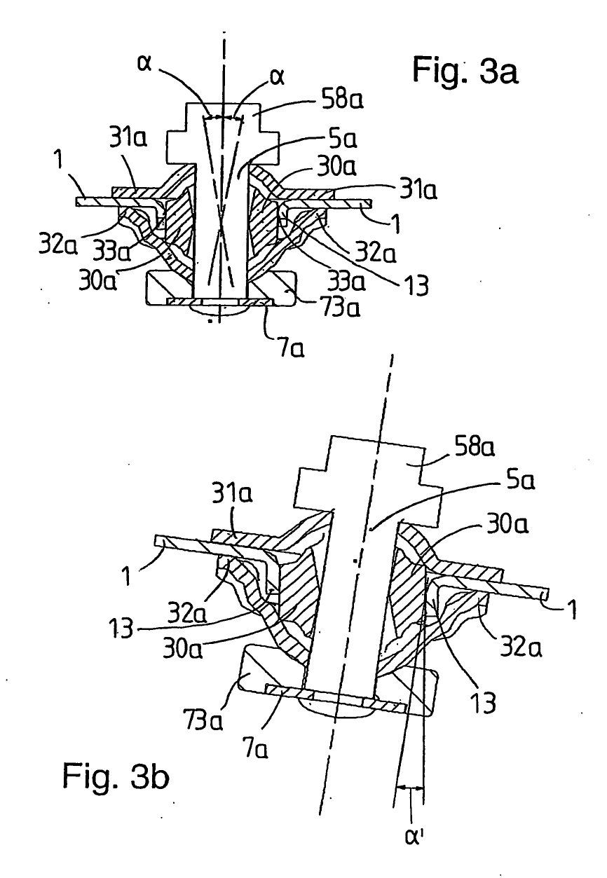

FIG. 3a a sectional view of a follower mounted on a guide way in a neutral function position;

FIG. 3b a sectional view of a follower mounted on a guide way in a tilted functioning position;

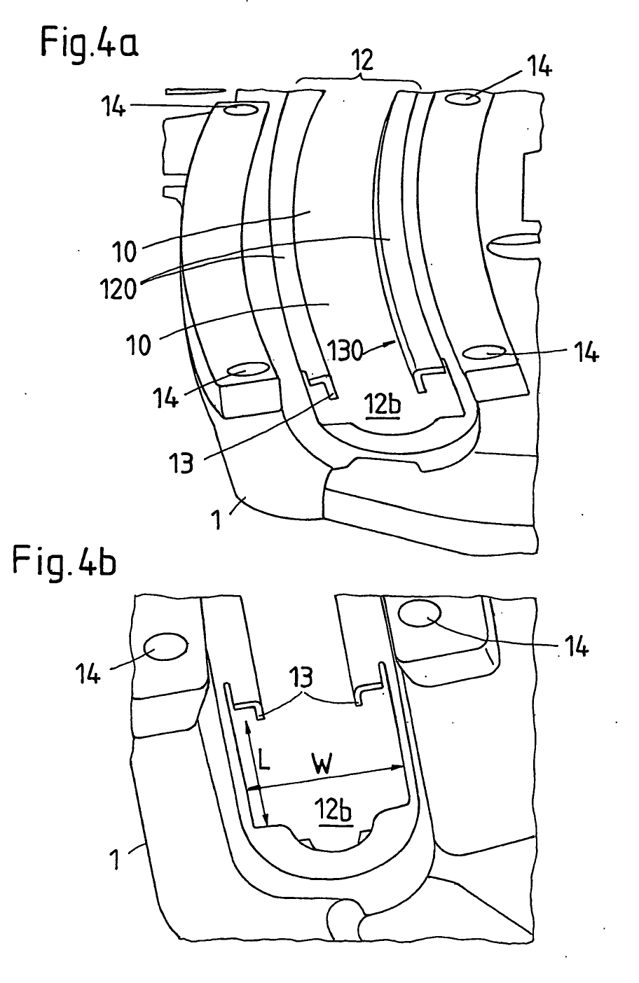

FIG. 4a a section of a guide plate with a part of a guide way;

FIG. 4b a detailed view of the guide way;

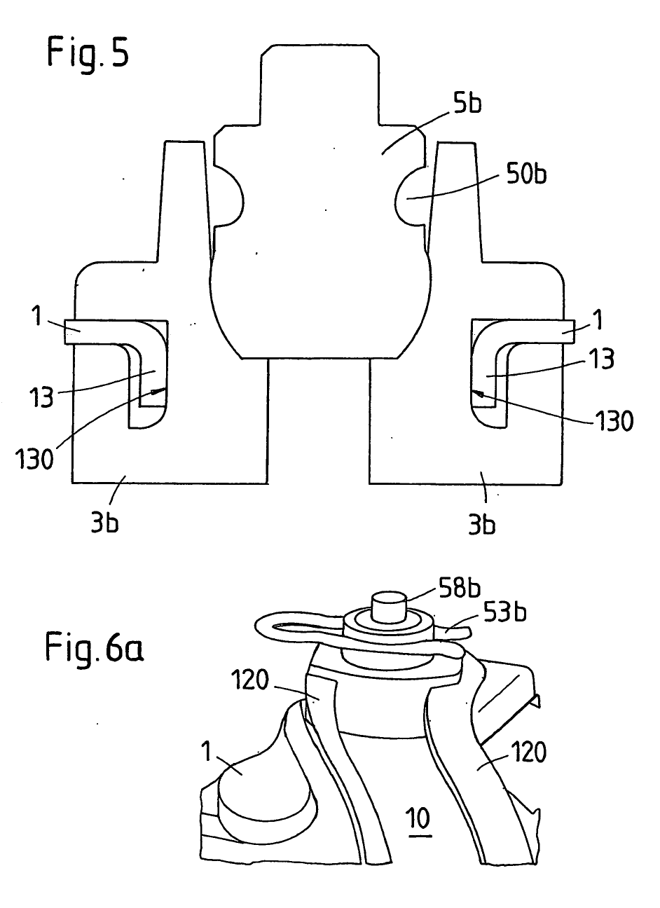

FIG. 5 a sectional view of a mounted follower with an expanding element;

FIG. 6a a three dimensional view of a section of a support plate with a fitted follower which has an expanding element;

FIG. 6b an exploded view of a follower with an expanding element and

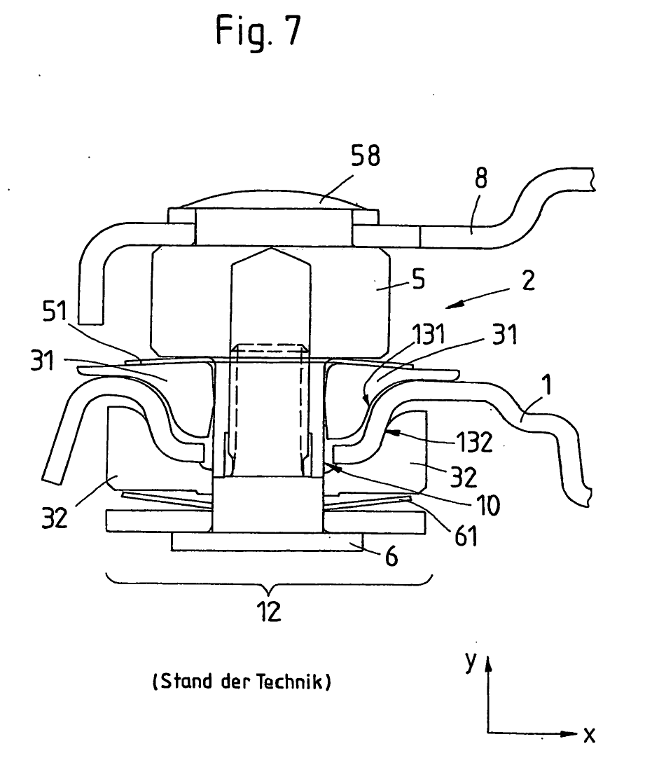

FIG. 7 a follower of the prior art mounted on a guide way.

FIGS. 1a to 1c and 2a and 2b show a follower of a continuously controlled window-lifter in a three-dimensional view. The follower has as a central element a stepped bolt 5a which enables a rivet connection 58a with a lifting rail (not shown) of the window lifter. For pre-assembly several component parts 310a, 320a and 7a are fitted on the stepped bolt 5a so that easy assembly is possible. The follower is to be prefabricated as a separate component which can be made by push-fit connections and can be positioned in an assembly position on the guide plate 1 so that this can be brought through the opening 10 in the guide way 12 and then fixed in the functioning position through a bayonet type movement of the second guide element 32a, which is shown by way of example in FIG. 1c.

The slide component 310a which has first been fitted on has a guide element 31a which is mounted to slide on the guide way 12 when the follower is fitted. A further slide component 320a with guide element 32a is mounted in the fitted state to slide on the surface of the guide way 12 of the guide plate 1 opposite this slide face 120 so that the guide way 1 (shown by way of example in FIG. 1c) is mounted between the first guide element 31a and the second guide element 32a. Between the first slide component 310a and the second slide component 320a there is a third slide component 30a which has a guide element 33a and is push-fitted onto the stepped bolt 5a. This guide element 33a is mounted to slide on a guide web 13 of the guide plate 1. This assembly structure of the follower which is also known by the term “sandwich construction” is held together through a fastening disc 7a which is fixed to the stepped bolt 5a by a rivet connection.

A side view of the follower of the continuously controlled window lifter is shown in FIG. 1b. The follower can be supplied in this pre-assembled position whereby the dimensions of the second and third guide components 21a and 30a do not exceed the width B. An exploded view of the same follower is shown in FIG. 2b. On the first guide component 310a on each side of the stepped bolt 5a there are detent noses 41a which in the preassembled state which is shown in FIG. 1b engage in detent grooves 421a of the second guide component 320a.

The detent noses 41a or the detent grooves 421a are designed to be elastic or are mounted elastically so that this positive locking fixing in this assembly position can be released through a manual assembly force. The holding force which counteracts the assembly force is however sufficient to prevent independent release of the fixing, by way of example under transport conditions. The three guide components 310a, 320a and 30a are mounted rotatable on the stepped bolt 5a. The second guide component 320a is in the preassembly position as shown in FIG. 1b turned 90° relative to the first guide component 310a in the preassembly position.

The width B in the preassembly position is designed so that it is smaller than or equal to a dimension of an opening 10 of a guide way 12, as shown in FIG. 3a. For assembly the follower as shown in FIGS. 1a and 1b is inserted into the opening 10 of the guide way 12 and then the second guide component 320a is turned opposite the first guide component 310a around 90° into the functioning position or intended position. The functioning position is shown in the exploded view in FIG. 2a. The first guide elements 31a are mounted to slide on the web faces 120 of the guide way 12. The guide elements 33a of the third guide component 30a are mounted to slide on track faces 130 of a web 13 of the guide way.

The fitted follower is shown in side view in FIG. 1c. The second guide element 32a thereby engages behind a web 13 of the guide way. Opposite the second guide element 32a mounted on the back of the guide support 1 the first guide element 31a is mounted on the front side opposite the second guide element 32a on the guide way 12. In order to fix the first and second guide element 31a and 32a in this position they are secured by a locking element 23a. The first guide element 31a and the second guide element 32a are stamped or cast out of metal for example. The sliding surface of the guide elements 31a, 32a is coated by way of example with polytetrafluoroethylene or the guide elements 31a, 32a are made from plastics.

The follower is preferably assembled in an assembly region MB of the guide way whereby the region MB has a guide web 13 of reduced height which is preferably shortened or flattened in the stamping bending process in order to make it easier to turn the second guide component 320a and thus for the guide web 13 to be engaged by the second guide element 32a through the rotational assembly process.

FIGS. 2c and 2d show the fixing of the “sandwich packet” of the follower by means of the locking element 73a. This locking element 73a can as shown in FIG. 2c be provided as a separate component part or a guide element 310a, 320a or can be integrated in the stepped bolt 5a of the follower. If the locking element 73a is provided as a separate element this is preferably made together with the second guide element 320a, 32a and can be separated therefrom through a rupturable region for assembly. In a first step the first guide element 32a and the first guide element 31a mounted on the front of the guide way are positioned on the guide way 12 and the locking element 37a is fitted onto the stepped bolt 5a in which the fastening disc 7a is guided through a matching opening in the locking element 73a.

In the following locking action which is shown in FIG. 2d the locking element 73a is turned so that the fastening disc 7a engages with positive locking connection in anti-rotation locks 730a of the locking element 73a so that the locking element 73a is prevented from turning back. In a double function this locking element 73a which can also be termed clip can serve as a nipple chamber if additional chambers for holding the nipples are formed in the locking element 73a. These nipples are connected to a cable (not shown) of the window lifter by means of which the follower can be moved along the adjusting path on the guide way 12. Furthermore the cable can prevent the locking element 73a from being turned out.

FIG. 3a shows a sectional view through the follower which is mounted on a guide way 12 in the assembled state. The follower is mounted in FIG. 3a in a region in which the stamping direction for positioning the opening 10 in the guide way 12 is substantially perpendicular to the surface of the guide way 12 of the guide plate 1. consequently the webs 13 are substantially at right angles to the surface of the guide way 12 in the guide plate.

The stepped bolt 5a is thus located in a central position which is substantially parallel to the guide webs 13. The third guide component 30a with guide elements 33a is mounted to slide on the guide webs 13. The third guide component 30a is mounted for swivel movement on the stepped bolt 5a through a tilt bearing so that the stepped bolt can be swivelled in an angle a when the position of the webs 13 deviates from a 90 degree position to the web faces 120 of the guide plate 1.

A deviation of this kind is shown in FIG. 3b whereby the stamping direction is not orthogonal to the web surface 120 of the guide support 1 but deviates from the orthogonal position by an angle α′. Consequently the stepped bolt 5a is shown tilted relative to the guide component 30a.

An alternative development of the invention is shown in FIGS. 4a ff. FIG. 4a shows a section of a guide support 1 with a guide web 12. The guide support can be fixed in the motor vehicle door through an assembly opening 14. The guide web 12 has an opening 10 through which a follower is passed. The web faces 120 of the guide way extend along the adjusting path of the follower. In addition the guide support 1 has a keyhole opening 12b to hold the follower which is shown enlarged in FIG. 4b. The keyhole opening 12b has no web faces 120 and also no guide webs 13 so that the opening 10 of the guide way 12 is widened out in the guide support 1 in the region of this assembly opening 12b. The width W and length L of this assembly opening are adapted to the dimensions of the follower for assembly.

A follower of this kind is shown in the exploded view in FIG. 6b. The slide component 3b is thereby inserted in the keyhole opening 12b of FIG. 4b and is pushed onto the guide way 12 with the web faces 120 and guide web 13. A follower fitted in this way is shown by way of example in FIG. 6a.

FIG. 5 shows a sectional view of the follower which is pushed onto the guide way 12 of the support plate 1. The region of the guide way 12 of the support plate 1 is shown with the guide webs 13 and the web faces 130 on which the follower is mounted for sliding movement with the slide component 3b. The slide component 3b thereby enables guidance over the thickness of the support plate 1 as well as over the webs 13 of the support plate 1. After sliding the slide component 3b onto the guide way 12 the spherical bolt 5b is inserted into the slide component 3b so as to spread this out and move it against the webs 13 of the guide way 12. In addition this spherical bolt 5b which acts as an expanding element has a ring groove 50b which can be brought into active connection with a spring clip 53b or a plate spring 53b so that the spherical bolt 5b cannot be forced out or slid out from the slide component 3b.

The guide web 13 preferably has a substantially perpendicular alignment to the web face 120 over the adjusting path, this can be produced with a particularly low tolerance by making the guide way 12 from plastics.

1. Follower for a continuously controlled window lifter which is mounted on a guide plate fixed in a motor vehicle and is displaceable along an adjusting path formed by a guide way, with
at least a first guide element which is mounted displaceable on the first side of the guide plate, and at least a second guide element which is mounted displaceable on the second side of the guide plate,
characterised in that
the second guide element is held in an assembly position relative to the first guide element and/or to another element of the follower through associated engagement regions, and
at least for assembly the first guide element and the second guide element are mounted movable relative to each other so that at least the second guide element can be brought from the assembly position into a functioning position on the guide way of the guide plate.

2. Follower according to claim 1, characterised in that the engagement regions are designed as a releasable positive locking connection for secure hold in the assembly position.

3. Follower according to claim 1, characterised in that the engagement regions are formed as a releasable force locking connection for secure hold in the assembly position.

4. Follower according to claim 1, characterised in that the engagement regions are formed as a rupturable regions for secure hold in the assembly position.

5. Follower according to claim 1, characterised in that for movable bearing the first guide element and the second guide element are mounted rotatable relative to each other.

6. Follower according to claim 1, characterised in that for movable bearing the first guide element and the second guide element are mounted displaceable relative to each other, more particularly displaceable in translation relative to each other.

7. Follower according to claim 1, characterised in that in the functioning position the first guide element and the second guide element are fixed relative to each other through a further positive locking and/or force locking connection.

8. Follower according to claim 7, characterised in that a locking element is provided for locking the fixing of the functioning position.

9. Follower according to claim 1, characterised in that the second guide element has as a positive locking engagement region a detent element, more particularly a detent nose or a detent groove.

10. Follower according to claim 1, characterised in that the follower has several slide members which each have at least a first guide element and at least a second guide element, at least the second guide elements of the slide members are mounted movable, more particularly rotatable, relative to a lifting rail, the second guide elements are positioned relative to each other and/or to the lifting rail in the assembly position, and the guide elements can be moved, more particularly rotated from the assembly position into the functioning position.

11. Follower according to claim 10, characterised in that the lifting rail has engagement regions more particularly positioning detent elements which act with the engagement regions of the second guide elements or with the engagement regions of the first guide elements to produce a secure hold in the assembly position.

12. Follower according to claim 11, characterised in that the positioning detent element of the lifting rail is designed as a pin which can be inserted into the lifting rail and which has in particular rupturable region which can be broken during assembly.

13. Follower according to claim 1, characterised in that for the movable bearing the second guide element is mounted rotatable on the first guide element or on a stepped bolt of the follower.

14. Guide plate for a continuously controlled window lifter in a motor vehicle, with
a guide way for guiding a follower of the window lifter and for adjusting the follower along an adjusting path which is formed by the guide way, and
a guide web of the guide way for guiding the follower in the plane of the guide way along the adjusting path,
characterised in that
the height of the guide web of the guide way is reduced in a region for assembling the follower.

15. Guide plate according to claim 14, characterised in that the guide way has either side of the guide plate and on the guide web track faces each associated with at least one guide element of the follower, and the guide plate has an opening in the guide way along the adjusting path through which the follower can be fitted into the region of the assembly.

16. Guide plate for a continuously controlled window lifter of a motor vehicle, with
a guide way for guiding a follower of window lifter and for adjusting the follower along an adjusting path formed by the guide way, whereby
the guide way has either side of the guide plate web faces which are each associated with at least one guide element of the follower
the guide way has an opening in the guide plate which is engaged by the follower,
characterised in that
in an extension of the guide way in the guide plate there is a region for fitting the follower, and the opening is widened out in this region to enable the follower to be pushed onto the guide way for assembly.

17. Follower for a continuously controlled window lifter which is mounted on a guide plate fixed in a motor vehicle, more particularly according to claim 16, and is displaceable along an adjusting path formed through a guide way, with guide elements which are mounted sliding on the guide way either side of the guide plate, wherein
at least a first guide element is mounted sliding on the first side of the guide plate, at least a second guide element is mounted sliding on the second side of the guide plate and between two guide webs of the guide way there is a third guide element whose width extends between the guide webs,
characterised in that
the width of the third guide element can be adjusted by an expanding element or by a mechanism adjusting the width of the third guide element, more particularly to the distance between the two guide webs.

18. Continuously controlled window lifter comprising a follower for a continuously controlled window lifter which is mounted on a guide plate fixed in a motor vehicle and is displaceable along an adjusting path formed by a guide way, with at least a first guide element which is mounted displaceable on the first side of the guide plate, and at least a second guide element which is mounted displaceable on the second side of the guide plate, wherein
the second guide element is held in an assembly position relative to the first guide element and/or to another element of the follower through associated engagement regions, and
at least for assembly the first guide element and the second guide element are mounted movable relative to each other so that at least the second guide element can be brought from the assembly position into a functioning position on the guide way of the guide plate
and a guide plate for a continuously controlled window lifter in a motor vehicle, with
a guide way for guiding a follower of the window lifter and for adjusting the follower along an adjusting path which is formed by the guide way, and
a guide web of the guide way for guiding the follower in the plane of the guide way along the adjusting path,
wherein
the height of the guide web of the guide way is reduced in a region for assembling the follower
wherein the follower can be driven along the guide way by means of a cable or a Bowden cable.

19. Continuously controlled window lifter according to claim 18, characterised in that the second guide element is able to swivel or rotate into an assembly position in which this second guide element can be brought through an opening in the guide plate associated with the guide way at the side of the first side of the guide plate to the second side of the guide plate.

20. Continuously controlled window lifter for a motor vehicle, with
a follower which is connected to the window pane and can be driven by means of a drive mechanism for adjusting the window pane, and
a guide way for adjusting the follower along an adjusting path (z-direction) formed by the guide way and for guiding the follower in a first guide direction substantially perpendicular to the adjusting direction of an adjusting path section and for guiding the follower in a second guide direction substantially perpendicular to the adjusting direction of the adjusting path section in which the first guide direction forms a variable angle over the adjusting path relative to the second guide direction, wherein
the guide way has an opening in a plate of the window lifter through which the follower is passed,
the guide way has for guidance either side of the plate web faces which are associated with guide elements of the follower,
the follower has at least a first guide element for guidance in the first guide direction (x-direction) and a second guide element for guidance in the second guide direction (y-direction), and
these guide elements and/or other elements of the follower have a bearing by means of which the first guide element and second guide element are mounted movable relative to each other, more particularly in dependence on the variable angle.

21. Continuously controlled window lifter according to claim 20, characterised in that the first guide element and the second guide element are mounted to swivel or rotate relative to each other by means of a swivel bearing or a rotational bearing.

22. Continuously controlled window lifter according to claim 20, characterised in that the first guide element is mounted on a ball joint and the ball joint is designed integral with the second guide element.

23. Continuously controlled window lifter according to claim 20, characterised in that the first guide element is mounted on a domed bearing of the second guide element.

24. Continuously controlled window lifter according to claim 20, characterised in that the first guide element is mounted on a tilting joint of the second guide element.

25. Continuously controlled window lifter according to claim 20, characterised in that the first guide element is mounted tilted on a stepped bolt of the follower which engages through the opening in the guide plate.

26. Continuously controlled window lifter of a motor vehicle comprising a follower for a continuously controlled window lifter which is mounted on a guide plate fixed in a motor vehicle and is displaceable along an adjusting path formed by a guide way, with
at least a first guide element which is mounted displaceable on the first side of the guide plate, and at least a second guide element which is mounted displaceable on the second side of the guide plate,
wherein the second guide element is held in an assembly position relative to the first guide element and/or to another element of the follower through associated engagement regions, and
at least for assembly the first guide element and the second guide element are mounted movable relative to each other so that at least the second guide element can be brought from the assembly position into a functioning position on the guide way of the guide plate and a guide plate for a continuously controlled window lifter in a motor vehicle, with
a guide way for guiding a follower of the window lifter and for adjusting the follower along an adjusting path which is formed by the guide way, and
a guide web of the guide way for guiding the follower in the plane of the guide way along the adjusting path,
wherein the height of the guide web of the guide way is reduced in a region for assembling the follower,
wherein the follower for guidance along the adjusting path has several slide members which are mounted to slide on at least a first, a second and a third guide way of the guide plate and engage through an opening in the guide way and
the follower is guided in a first guide direction substantially orthogonal to the surface of the guide plate and through restrictions of the opening of the guide way in a second guide direction,
wherein the opening of the (outer) first guide way is wider than that of the second and third guide ways, and
the follower is guided in the second guide direction only through the second guide way and the third guide way.
